(19) United States
(12) Patent Application Publication
(10) Pub. No.: US 2017/0279313 A1
(43) Pub. Date: Sep. 28, 2017

(54) INDUCTIVE POWER TRANSMITTER

(71) Applicant: PowerbyProxi Limited, Freemans Bay, Auckland (NZ)

(72) Inventors: Aiguo HU, Freemans Bay, Auckland (NZ); Jianlong TIAN, Freemans Bay, Auckland (NZ)

(73) Assignee: PowerbyProxi Limited, Freemans Bay, Auckland (NZ)

(21) Appl. No.: 15/505,336

(22) PCT Filed: Aug. 13, 2015
(86) PCT No.: PCT/NZ2015/050109

§ 371 Date: Feb. 21, 2017

Related U.S. Application Data
(60) Provisional application No. 62/040,063, filed on Aug. 21, 2014.
(60) Provisional application No. 62/153,784, filed on Apr. 28, 2015.

(51) Int. Cl. H02J 50/12; H02M 7/538

(52) U.S. Cl. CPC H02J 50/12; H02M 7/53803; H02M 2007/4818

(57) ABSTRACT

An inductive power transmitter comprising: at least two switching elements connected across a resonant circuit, the resonant circuit including an inductance and a capacitance; wherein the transmitter is configured to adjust the value of the capacitance based on a desired operating frequency.

### FIELD

This invention generally to an inductive power transmitter.

### BACKGROUND

IPT technology is used to transfer electrical energy from a transmitter coil to a receiver coil using magnetic field coupling between them. However, as there is usually a relatively large air gap between the transmitter and receiver coils, and magnetic energy drops off sharply with distance, the magnetic flux reaching the receiver coil from the transmitter coil is much weaker in IPT systems than in traditional tightly-coupled transformers and electric motors. This greatly limits the power transfer ability and efficiency of IPT systems.

Two techniques commonly used to increase the transfer efficiency are to increase the inverter frequency or to match the operating (i.e., resonant) frequency of the receiver to that of the transmitter side. To match the resonant frequencies, stabilizing the frequency of the transmitter may be desirable. However, when the transmitter inverter is resonant mode/soft switched, its frequency is usually not fixed and when the frequency of the inverter is fixed, it is usually not soft switching/resonant mode.

Varicaps are an example of a solution used in low power oscillating circuits to adjust the operating frequency allowing stabilisation of the frequency of an inverter or converter that has been soft switching, but they are not suitable for the higher voltages found in IPT circuits.

For example the inverter in International Patent Publication number WO2007/015651 is a push pull current fed resonant inverter for IPT. In that case it is soft switched but not fixed frequency. However prior art attempts to stabilise and/or adjust the frequency of such an inverter may suffer from additional complexity, higher losses, EMI problems, inflexibility in frequency and/or bulkiness.

### SUMMARY

In general terms in a first aspect one or more voltage controlled variable capacitors may be introduced into a switch mode resonant inverter. This may have the advantage that the inverter becomes a voltage controlled oscillator (VCO) and/or that the frequency of an inductive power transmitter can be adjusted.

In a second aspect the operating frequency of an IPT inverter may be controlled with a Phase Locked Loop (PLL). A PLL would not be expected to work in a power electronics circuit as the voltages and currents are too high, being of the order to several tens of Volts and several hundreds of milliAmps, for such lower power components. This may have the advantage that the operating frequency of an inductive power transmitter may be stabilised through the feedback loop.

According to one example embodiment there is provided an inverter comprising at least two switching elements connected across a resonant circuit, the resonant circuit including an inductance in parallel with a capacitance, and wherein the inverter is configured to adjust the value of the capacitance based on a desired inverter operating frequency.

According to another example embodiment there is provided an inductive power transfer system comprising: an inverter, and a phase locked loop configured to control the operating frequency of the inverter.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a block diagram of an inductive power transfer transmitter according to an example embodiment;

FIG. 2 shows a circuit diagram of an example transmitter;

FIG. 3 shows a graph of the relationship between the ratio of the conduction time of the diode to the period and the equivalent capacitance when both C1 and C2 are 300 nF;

FIG. 4 shows a graph of the relationship between the control voltage and the conduction time of the diode;

FIG. 5 shows a graph of the relationship between the control voltage and the frequency of the autonomous push pull inverter;

FIG. 6 shows a circuit diagram of the an example inverter;

FIG. 7 shows a graph of experimental results of the relationship between the frequency and the controlling voltage;

FIG. 8(a) shows a graph of Va, VD3 and Fref when Fref is 230 kHz;

FIG. 8(b) shows a graph of Va, VD3 and Fref when Fref is 235 kHz;

FIG. 8(c) shows a graph of Va, VD3 and Fref when Fref is 242 kHz;

FIG. 9(a) shows a graph of Va, VD3 (23.41V) and Fref;

FIG. 9(b) shows a graph of Va, VD3 (21.48V) and Fref;

FIG. 9(c) shows a graph of Va, VD3 (11.69V) and Fref;

FIG. 9(d) shows a graph of Va, VD3 (6.26V) and Fref; and

FIG. 10 shows an alternative inverting voltage amplifier.

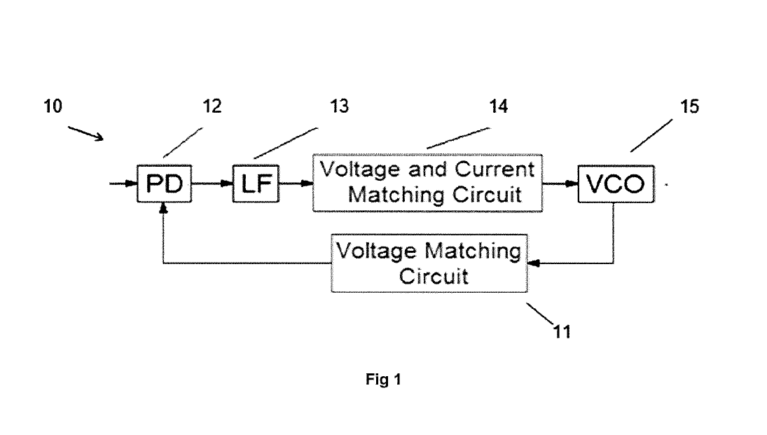

### DETAILED DESCRIPTION OF EMBODIMENTS OF THE INVENTION

An inductive power transfer (IPT) system has an inductive power transmitter and an inductive power receiver. The transmitter includes a power transmission element or elements, such as an inductive (primary) coil or coils, and the receiver includes a power receiving element or elements, such as an inductive (secondary) coil or coils. Power is transferred between these elements due to magnetic coupling of the elements. It is understood that the use of the term “coils” herein is meant to designate inductive “coils” in which electrically conductive wire is wound into a three dimensional coil shapes or two dimensional planar coil shapes, electrically conductive material is fabricated using printed circuit board (PCB) techniques into three dimensional coil shapes over plural PCB ‘layers’, and other coil-like shapes. The use of the term “coils” is not meant to be restrictive in this sense.

Figure shows 1 an example embodiment of an inductive power transmitter 10. The transmitter 10 has a negative feedback loop configured to improve the stability of the operating frequency. In the specific context of IPT systems, this may allow the operating frequency of the transmitter to be stabilised at the receiver resonant frequency in a simple, low cost, small, efficient, and/or flexible manner. In particular this may increase the efficiency of power transfer and/or increase the range of operating conditions. The establishment and control of operating and resonant frequencies in IPT systems is well understood by those skilled in the art, and therefore not discussed in detail herein. Depending on the application it may alternatively be desirable for the receiver to match its resonant frequency to that of the transmitter using an adaptation of the technique described below.

The negative feedback loop may be a modified phase locked loop. An error detector (in this case phase detector (PD) 12) compares a predetermined desired frequency to the operating frequency of the transmitter 10. The output of the PD 12 is filtered by a loop filter (in this case low pass filter (LF) 13). The filtered error voltage is then used to adjust the operating frequency of transmitting circuitry 15 of the transmitter 10. Components 11 & 14 will be discussed later.

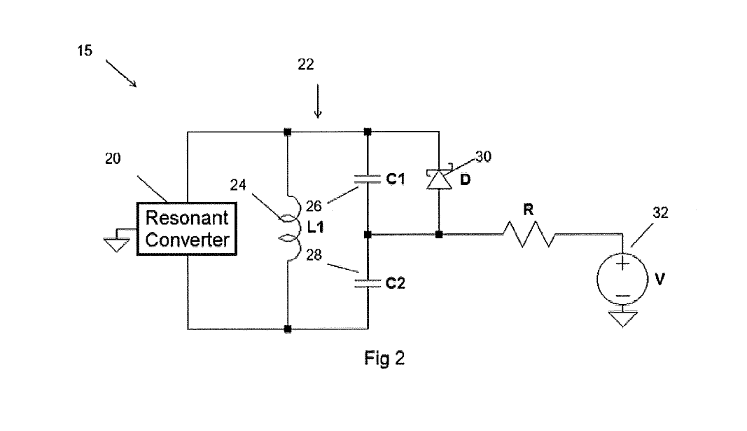

An example of the transmitting circuitry 15 is shown in FIG. 2. An inverter 20 is connected to an appropriate power supply. The inverter 20 supplies an AC current to a transmitter resonant circuit 22. The transmitter resonant circuit includes a transmitting coil 24 and transmitter capacitors 26,28. The transmitting coil 24 and the transmitting capacitor 26 may be connected in parallel or in series to create a resonant circuit. The transmitting coil 24 generates an alternating magnetic field suitable for inductive power transfer to the receiver.

In order that the filtered error voltage adjusts the operating frequency in the transmitting circuitry 15, the transmitting capacitor in the resonant circuit is an equivalent voltage control variable capacitor (EVCVC). The EVCVC capacitance can be controlled by an input voltage. As the transmitter operating frequency depends on the capacitance, this allows the transmitter to operate equivalently to a voltage controlled oscillator (VCO).

The EVCVC therefore enables the operating frequency of an inductive power transmitter to be adjusted in a simple, low cost, small, efficient, and/or flexible manner. In particular this may allow transmitter to adapt to the resonant frequency of multiple different receivers. For example the operating frequency may be manually switched between standard receiver resonant frequencies or it may be adapted in real-time, in response to a particular detected receiver. This may be done, for example, by detecting the identity of the receiver and using a lookup table, or by measuring the receiver resonant frequency directly.

For example the EVCVC may include the two capacitors 26, 28 in series and a diode 30 in parallel with the one capacitor 26. The filtered error voltage output 32 is provided at the positive terminal of the diode 30. The filtered error voltage output 32 thereby determines the equivalent value of the capacitance of the EVCVC. As is explained below, the higher the filtered error voltage output 32 is, the larger the equivalent capacitance of the EVCVC.

The two capacitors 26,28 together in series have a correspondingly lower capacitance than either of the capacitors individually. As such the higher the voltage on the positive terminal of the diode 30 is, the longer the diode 30 conducts. When the diode 30 conducts it shorts the capacitor 26, and therefore increases the effective capacitance to the capacitor 28.

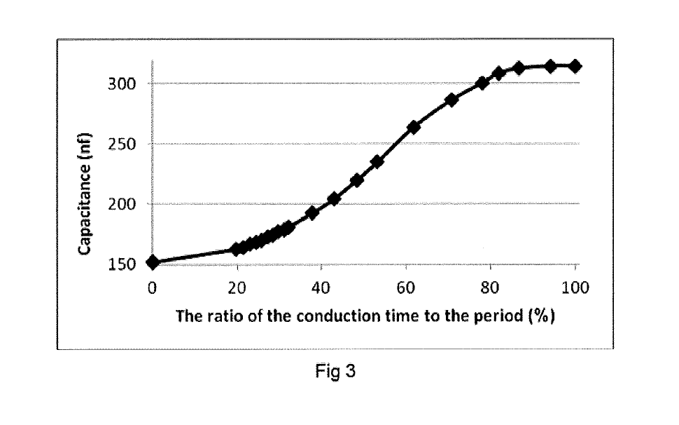

This relationship has been simulated as shown in FIG. 3. The horizontal axis represents the duty cycle of the conduction time of the diode and the vertical axis is the equivalent capacitance of the EVCVC. Both of the values of the capacitors 26,28 used in the simulation are 300 nf and therefore the value of the capacitance of the capacitors 26,28 in series is 150 nf. It can be seen from FIG. 3 that the value of the capacitance is about 314.5 nf when the ratio is 100% meaning the diode 30 always conducts and the value of the capacitance is roughly 152.2 nf when the ratio is 0% meaning the diode 30 never conducts. Ignoring the errors of the measurement, as predicted, the value of the equivalent capacitance indeed changes roughly between 300 nf and 150 nf, which proves the assumption that the equivalent capacitance of the EVCVC changes roughly between the value of the capacitor 28 and the value of the capacitors 26,28 in series.

Actually the instantaneous capacitance of the EVCVC switches between the above two discrete values, namely the capacitance of the capacitor 28 and the value of the capacitors 26,28 in series in accordance with the diode 30 to be conducting and to be not conducting. Thus the equivalent capacitance value is the average value which varies according the length of the conduction time of the diode compared to the non-conduction time i.e. the duty cycle.

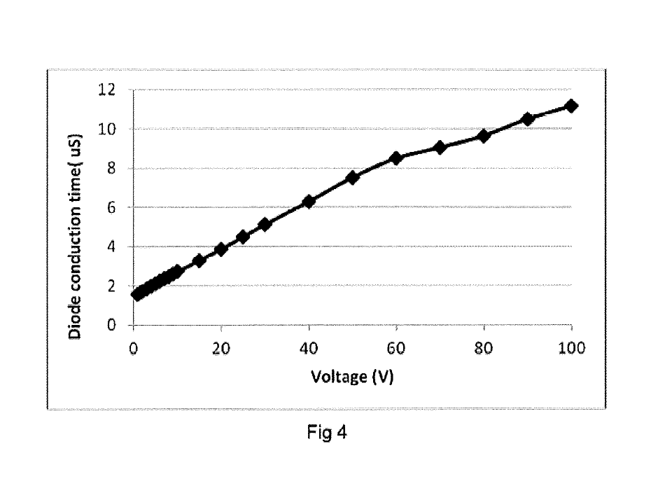

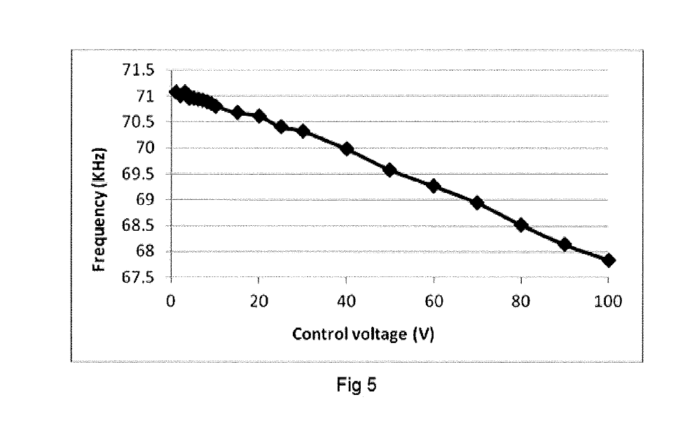

Because the voltage at the negative terminal of the diode is AC (between 0V to π.V_{DC}), the magnitude of the DC voltage at the positive terminal will be approximately proportional to the duty cycle of the conduction time. FIG. 4 shows this relationship between the control voltage and the conduction time of the diode, from which it can be seen that as predicted, the conduction time of the diode is positively related to the control voltage. From the relationships in FIGS. 3 & 4, the higher the control voltage is, the lower the operating frequency will be, namely they are negatively related to each other because the frequency is reversely related to the capacitance, as shown in FIG. 5.

The arrangement of the diode based EVCVC may be termed a passive switched capacitance. The capacitor may also be actively (or synchronously) switched using a transistor, depending on the application requirements.

The PD 12 and the LF 13 can be chosen by a person skilled in the art according to the application requirements, for example from low power signal processing components. For example phase comparator of the PLL chip CD4046BE can be used for the PD 12, and there are technical details in the datasheet of CD4046BE for designing the corresponding LF 13.

The two voltage and current matching circuits 11 & 14 mentioned earlier are used because the transmitting circuitry 15 is not a low power signal processing circuit like the PD 12 and the LF 13. In particular because the voltage and current ratings of the former are much larger than those of the later the voltage and current matching circuits 11 & 14 are needed in front of and behind the transmitting circuitry 15.

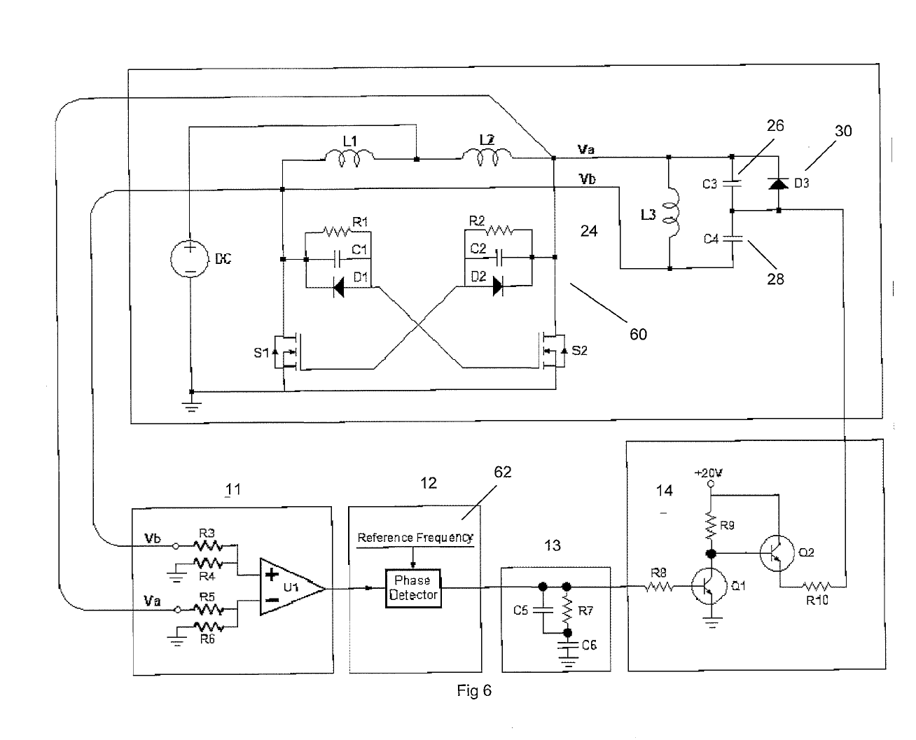

The inverter 20 may be a resonant inverter. For example it may be an autonomous push pull inverter or current fed push pull resonant inverter. In a particular embodiment, FIG. 6 shows the voltage and current matching circuits 11 & 14 integrated into a current fed push pull resonant inverter 60.

For example a voltage attenuator and comparator 11 converts the real oscillating frequency of the inverter 60 continuously into a square wave. The DC supply voltage V_{DC} may be 10-30V and the resonant voltage across the transmitter coil 24, is π times this, for example up to 100V. A set of voltage dividing resistors R₃, R₄, R₅ and R₆ attenuate the resonant voltage down to within the input voltage range of the comparator U1 eg: under 5V or lower. The square wave from U1 is therefore input to the PD 12 at a much lower magnitude.

The PD 12 compares this square wave with a fixed reference frequency input 62, and the LF 13 outputs a voltage of 0-5V which changes according to the difference of those frequencies.

The LF output voltage is not high enough to be used as the controlling voltage for the EVCVC which needs to be from 0V up to the peak voltage of the resonant circuit 22 to control the diode 30 to the maximum adjustable range. Depending on the fluctuation range of the frequency, the maximum value of the controlling voltage can be designed lower than the peak value of the voltage of the resonant circuit 22 as long as the fluctuating frequency can be adjusted back to the reference frequency. The general principle for determining the maximum value of the controlling voltage is that the higher the controlling voltage is, the larger the adjustable range of the frequency. Another factor which has an influence on the design of the maximum value of the controlling voltage is the resistance of the resistor R₁₀. The larger the resistance of R₁₀ is, the less the influence of the voltage at the emitter of the transistor Q₂ is on the controlling voltage at the positive terminal of the diode 30. Also the adjustable range of the frequency can be enlarged by lowering the value of the resistor R₁₀, however, the lower the value of the resistor R₁₀ is, the more power it will consume.

The inverting voltage amplifier 14 in FIG. 6 amplifies the voltage signal from the LF (which changes only between 0-5V) in both voltage and current levels so that they become high enough to be used as the controlling voltage for the EVCVC. The amplifier 14 also inverts the phase of the voltage, namely its output voltage should be reversely related to its input voltage. This is because the controlling voltage is reversely related to the frequency of the inverter as shown in FIG. 5, however, the PLL chip used in the simulation (CD4046BE) requires a positive relationship between its output voltage and the frequency of its VCO. This is guaranteed after the voltage is inverted twice, namely the inversion by the amplifier 14 and the inversion of the relationship between the frequency and the controlling voltage as shown in FIG. 5. The task of voltage amplification and inversion is accomplished by the NPN transistor Q₁ and the function of the NPN transistor Q₂ is to fulfil the task of current amplification.

Other voltage attenuator/comparator and inverting voltage amplifier circuits may be employed according to the application. For example they may be required to scale the voltage by a factor of between 2-20 times.

The inductive power transmitter may include a magnetically permeable element or core for the transmitting coil. The magnetically permeable core may be made from a ferrite material. When the transmitting coil is planar, the magnetically permeable core may be placed so that it is underneath the transmitting coil, or the transmitting coil may be wound around the magnetically permeable core itself.

The inductive power receiver may include a receiver resonant circuit. The receiver resonant circuit includes a receiving coil(s) and a receiver capacitor(s). The receiving coil and the receiver capacitor may be connected in parallel or in series to create a resonant circuit. The receiver resonant circuit will have a corresponding resonant frequency. As will be discussed in more detail later, the transmitter resonant circuit may be configured so that its resonant frequency matches the resonant frequency of the receiver resonant circuit.

There may be multiple transmitter resonant circuits and/or multiple receiver resonant circuits. For example, in a charging pad there may be an array of transmitting coils, which may each be connected to an associated resonant capacitor or other impedance element(s) for establishing resonant conditions in the circuit. Similarly in some portable devices there may be receiving coils located on different parts of the portable device Such transmitter resonant circuits may all be connected to the inverter 20, or they may each be connected with an associated inverter. It may be possible to selectively energise each or some of the transmitter resonant circuits and/or transmitting coils, and similarly the receiver mutatis mutandis.

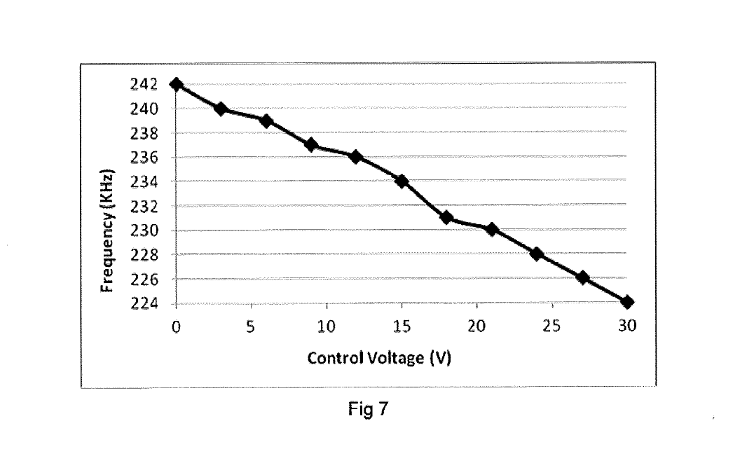

FIG. 7 shows an experimental result of the relationship between the control voltage and the frequency of the push pull inverter with the circuit shown in FIG. 6. The control voltage added to the positive terminal of the diode 30 through a 100Ω resistor. It can be seen that when the control voltage increases from 0 to 30 volts, the frequency decreases from 242 kHz to 224 kHz changing 18 kHz in total.

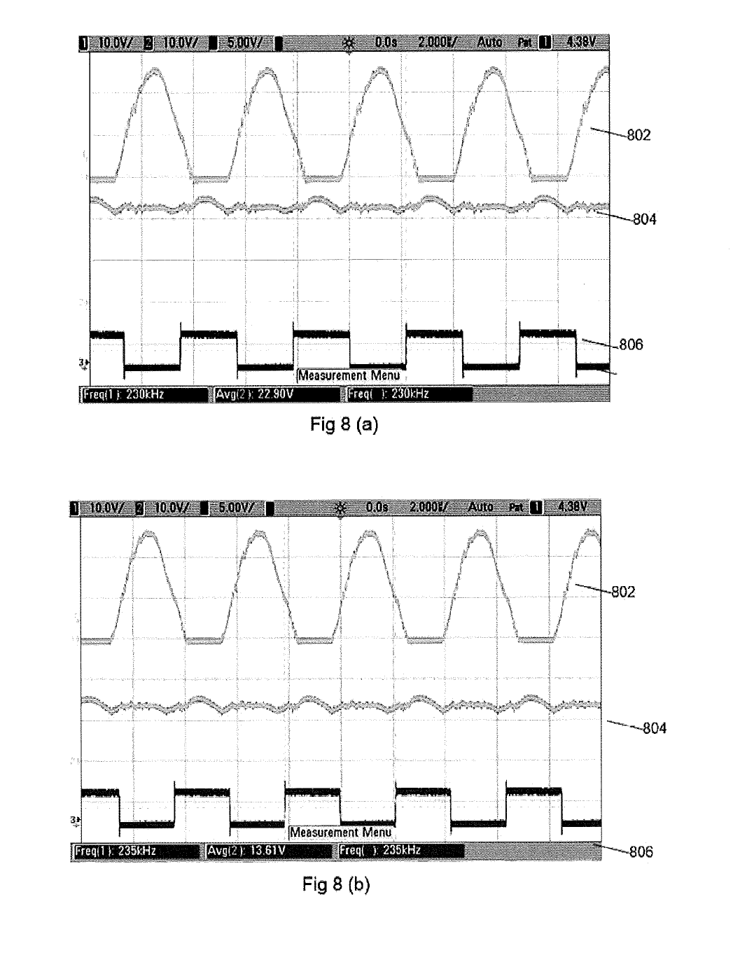

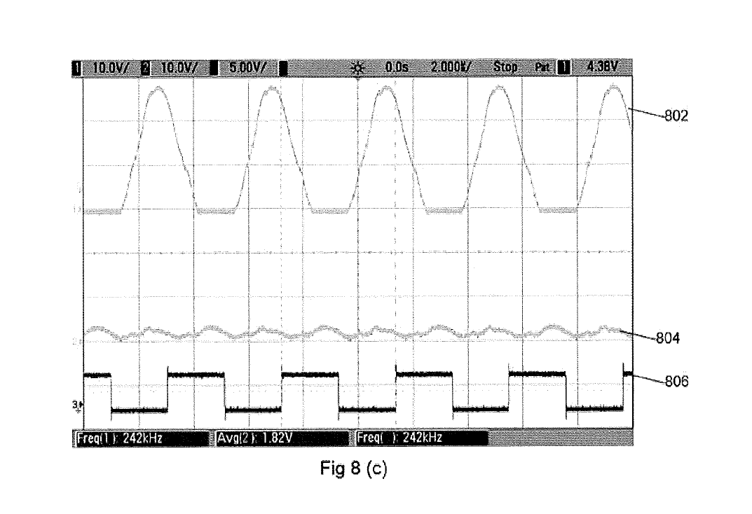

FIGS. 8(a), (b) and (c) show experimental results of the following parameters of the whole PLL control loop (as shown in FIG. 6) when the reference frequency is set at three different values:
The voltage of the resonant tank (Vₐ, 802);
The average voltage on the positive terminal of the diode D₃ (VD3, 804); and
The reference frequency as shown in PD 12 (F_{ref}, 806).

FIGS. 8(a), (b) and (c) are summarized in Table 1:

| | Frequency of Va (kHz) | VD3 (V) | Fref (kHz) |
|---|---|---|---|
| FIG. 8(a) | 230 | 22.90 | 230 |
| FIG. 8(b) | 235 | 13.61 | 235 |
| FIG. 8(c) | 242 | 1.82 | 242 |

Two points can be seen clearly from Table 1. Firstly, the frequency of the voltage of the resonant circuit follows the reference frequency which means the reference frequency has control over the frequency of the resonant circuit. Secondly, the higher the controlling voltage on the positive terminal of the diode 30 is, the lower the frequency of the inverter, which agrees with both of the simulation and experimental results as shown in FIGS. 5 and 7 respectively.

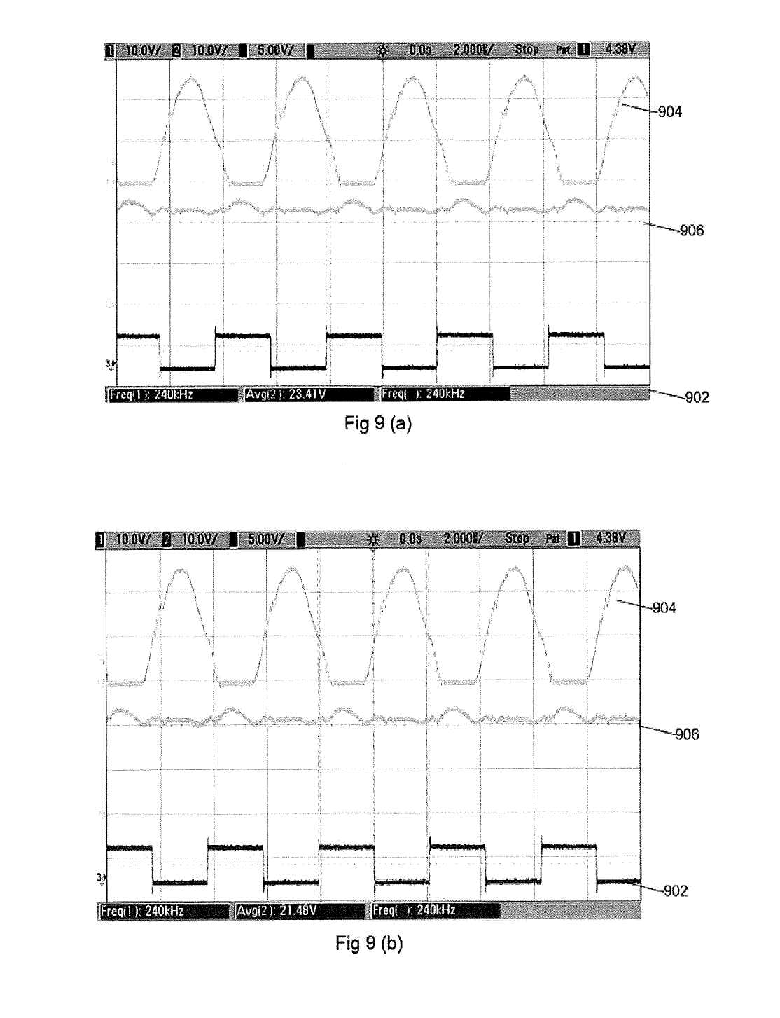

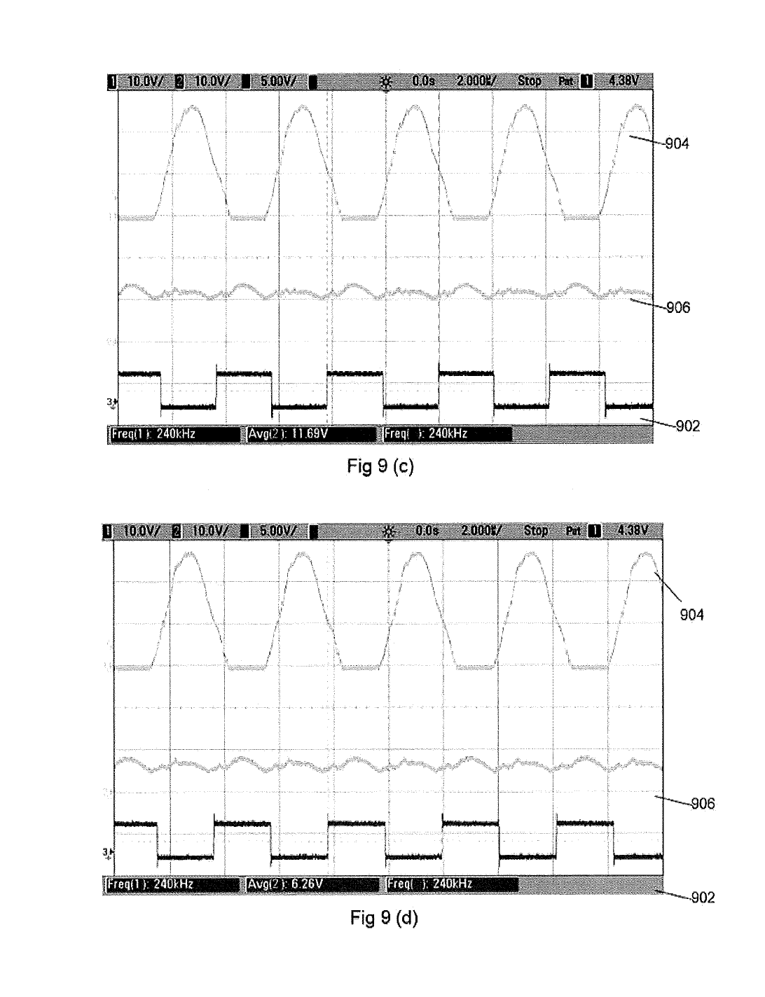

FIGS. 9(a), (b), (c) and (d) show the experimental results when the reference frequency 902 is set at 240 kHz and a receiver coil is coupled to the transmitter coil 24 at different distances. The frequency of a prior art resonant inverter will change greatly at such situations (as the load impedance of the secondary coil is coupled through the primary coil, and this changes significantly depending on the gap between transmitter (primary) and receiver (secondary) coils). However, it can be seen from FIG. 9 that the frequency 904 of inverter does not change but is substantially stabilised at the 240 kHz reference frequency. The controlling voltage V_{D3} 906 does change meaning the controller is stabilising the frequency by adjusting the controlling voltage V_{D3}.

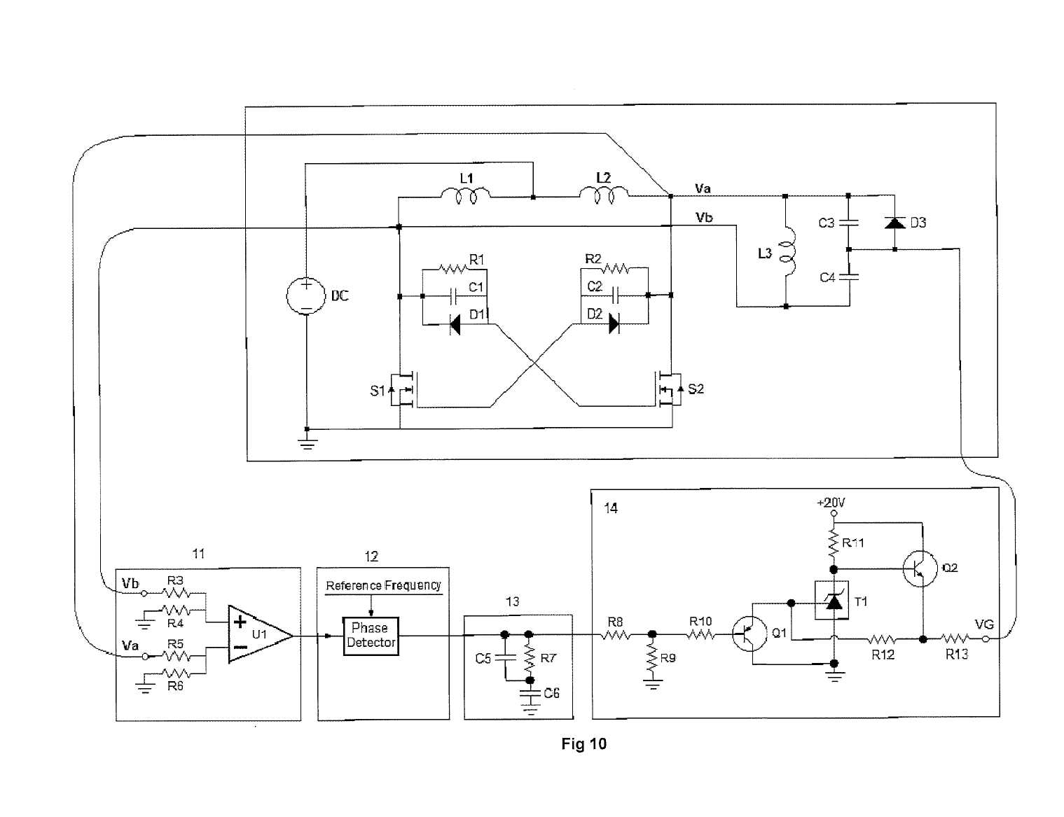

FIG. 10 shows an alternative inverting voltage amplifier 14. The reminder of the transmitter 10 is similar to that shown in FIG. 6. In this case an adjustable precision shunt regulator, T₁ is introduced to improve the stability of the current amplification role of Q₂. This has the effect of providing a smoother voltage feedback signal to the transmitting circuitry 15 which ensures that the operating frequency does not suffer from jitter or noise. Also the voltage divider of R₈ and R₉ reduces the 0˜5V output voltage from the low pass filter to 0˜2.5V for the base of Q₁.

T₁ may for example be a TL431™manufactured by Texas Instruments Incorporated. The output voltage of T₁ is adjusted by reference to the emitter of transistor Q₂ through feedback resistor R₁₂. The reference voltage is proportional to the current at V_{G}. The output voltage from the regulator then controls the base voltage of Q₂. This introduces a current threshold to the switching of Q₂.

Q₁ works in linear mode and functions as a variable resistor controlled by its base voltage. The function of Q₂ is to increase the output current range of TL431. The voltage at the emitter of Q₂ is roughly inversely related to the resistance of Q₁, namely the smaller the resistance of Q₁ is, the larger the voltage at the emitter of Q₂. As a result, the output voltage of the inverting voltage amplifier 14 is inversely related to its input voltage because the larger its input voltage is, the smaller the resistance of Q₁.

While embodiments have been illustrated by the description, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power transmitter comprising:
at least two switching elements connected across a resonant circuit, the resonant circuit including an inductance and a capacitance;
wherein the transmitter is configured to adjust the value of the capacitance based on a desired operating frequency.

2. The transmitter in claim 1 wherein the capacitance comprises a voltage-controlled variable capacitor.

3. The transmitter in claim 2 wherein the capacitance comprises a passive voltage-controlled variable capacitor.

4. The transmitter in claim 2 wherein the capacitance comprises two capacitors in series and a diode in parallel with a first of the capacitors.

5. The transmitter in claim 4 configured to receive a positive DC voltage at the positive terminal of the diode to adjust the value of the capacitance.

6. The transmitter in claim 5 configured to receive the positive DC voltage at a resistor connected the positive terminal of the diode.

7. The transmitter in claim 5 wherein the DC voltage is substantially inversely proportion to the operating frequency.

8. The transmitter in claim 1 wherein the at least two switching elements comprise an autonomous push pull inverter or a current fed push pull resonant inverter.

9. The transmitter in claim 1 wherein the inductance is in parallel with the capacitance

10. An inductive power transfer system comprising:
an inductive power transmitter, and
a phase locked loop configured to control the operating frequency of the transmitter.

11. The system in claim 10 wherein the transmitter comprises at least two switching elements connected across a resonant circuit, the resonant circuit including an inductance and a capacitance, wherein the transmitter is configured to adjust the value of the capacitance based on a desired operating frequency, wherein the phase locked loop is configured to adjust the value of the capacitance and wherein the inductance is a transmitter coil for inductive power transfer.

12. The system in claim 10 further comprising a voltage attenuator and a comparator between an output side of the transmitter and the phase locked loop and an inverting voltage amplifier between an input side of the transmitter and the phase locked loop.

13. The system in claim 12 wherein the inverting voltage amplifier includes a current amplifier, and a voltage amplifier and inverter.

14. The system in claim 13 wherein the current amplifier includes an adjustable precision shunt regulator.

15. The system in claim 10 wherein the transmitter is configured as a voltage controlled oscillator.

16. The system in claim 10 further comprising an inductive power receiver having a resonant frequency, wherein the operating frequency of the transmitter is substantially controlled to the receiver resonant frequency.

17. The system in claim 16 wherein the receiver resonant frequency is selected from a predetermined set of frequencies, determined based on a receiver identifier, or determined directly from the receiver.
